(19) United States
(12) Patent Application Publication
(10) Pub. No.: US 2026/0367211 A1
(43) Pub. Date: Nov. 19, 2026

(54) EMERGENCY ALERT AND TRACKING SYSTEM AND METHOD

(71) Applicant: Sigflare LLC, Farmingdale, NY (US)

(72) Inventors: Joseph Scaglione, Farmingdale, NY (US); George Carlucci, Commack, NY (US)

(21) Appl. No.: 19/682,296

(22) Filed: May 19, 2026

Related U.S. Application Data
(60) Provisional application No. 63/808,176, filed on May 19, 2025.

(51) Int. Cl. G01S 5/02; G06F 21/12; G08B 25/00; G08B 25/12; H04W 4/029; H04W 4/90

(52) U.S. Cl. CPC G01S 5/0231; G06F 21/123; G08B 25/008; G08B 25/12; H04W 4/029; H04W 4/90; G06F 2221/2111

(57) ABSTRACT

The invention is an emergency alert and tracking system with a pendant and receiver that allows a user to share their location with a group members in real time during an emergency situation but keep their location private when not in an emergency situation. The invention includes real time audio and GPS communication between a user and a teammate using mobile devices during an emergency. The group members can maintain the privacy and keep their location private when they are not calling for assistance.

### FIELD OF THE INVENTION

The invention is an emergency tracking device and system that allows teams of first responders to be directly alerted to the location of someone in need of assistance ( a “person in need”) and to receive information about the location of the person in need, in real time, without information having to first travel to a relay point or a middleman. It directly alerts those first responders to the location where assistance is needed.

### BACKGROUND OF THE INVENTION

Police officers often work in areas with high crime activity. There are many situations where responding officers could have been able to get to the location of an officer-in-need quicker and more efficiently had there been a mobile application or system that sent real time alerts and locations for an officer in need. Often, whether an officer is chasing, confronting or is in an altercation with a suspect, a spike of adrenaline can occur causing an officer’s fine motor skills and mental acuity to be compromised. During these times of crisis and in emergency situations, an officer-in-need’s only tool for summoning help or assistance is their mobile radio communication system in which the officer must accurately and clearly vocalize and send an audio communication giving their specific location. The problem with the radio and audio communication is that there is usually noise and commotion that interferes with the communication making communication inaudible. Voice communications can be inaudible as a result of the situation when the officer-in-need and responding officers share the same line for audible communications and their messages interfere with each other and cut off each other’s communication. This leads to preventing those in need from accurately and efficiently conveying their location. In moments of stress, a minute may feel like an eternity. Further, in times of crisis, a quick and efficient response communicating one’s location can be lifesaving.

There are several advantages to the invention including, allowing one to send out an alert without having to use the fine motor skills since activation of an alert is simple and quick. Second, sometimes a user is unfamiliar with the location. They can be unable to accurately give their location, and in times of stress, they may be mistaken about their exact location. The inventive system sends out a user’s updated location to the responding team based on the GPS location of the user’s electronic device. Third, many people who do not wish to have their location being shared indefinitely can be part of a team and can request assistance without losing their privacy during a team session. The invention only sends and shares a user’s GPS location when help is needed, and the sharing of location is terminated when assistance is no longer needed.

### SUMMARY OF THE INVENTION

The invention contemplates as a first step setting up a predetermined team of responders through a software application on the mobile alert system. A team could be made up any group of people with a common purpose, such as police officers, firefighters, paramedics, first responders, or any combination of such groups. An example of one embodiment of the invention is a police officer team leader would start a group with one or more initial member officers. Other officers would also be allowed, with permission, to add themselves to the group. An officer user would then turn on the application on a mobile GPS device such as mobile phone or stand-alone GPS device. The application would remain on in the background during an officer user’s work shift, however the system will only transmit the GPS location of the user when the user decides to transmit and share their location. In an emergency situation, a user can initiate sharing of their location by transmitting and sending out their exact location by clicking a physical button on a mobile device or pendent that the user carries, (such as an Apple Phone™ or Apple Watch™). This mobile pendent can be mobile GPS device or electronically paired to a mobile GPS device. In one embodiment, the button is pushed three times in succession to activate the system to send out an alert notification to those others on the predetermined team as well as opening a group call so the team members can receive any pertinent information. In the preferred embodiments, at least three quick pushes to a button are required to activate the system. Alternatively, the alarm can be activated on a smartwatch like an Apple Watch™ by a fast turn of the dial on side of the watch. The benefit of the alternative embodiment is that sometimes when tapping on the mobile pendant, the user has to be precise with the clicks by using only one finger, if more than one finger is used then it will shut off the watch face. The alternative spin of the dial is quicker and easier to do so. Both these activation methods balance the need for quick and easy activation with the problem of inadvertent activation.

Some team members may not want their location tracked by every other team member at all times of day during a session. The invention allows team members privacy during a session, while at the same time allowing a team member the ability to send out their location to the rest of the team members in an instant if assistance is needed.

When team members, such as other officers, receive an alert, a map on their mobile phone will automatically appear and show the quickest way to get to the user who initiated the sharing of their location, such as an officer-in-need of assistance. In order to terminate the alert, the user holds down the button on the pendant for 5 seconds and the GPS signal sent to other team members is terminated. Alternatively, the user can deactivate the alarm by going into the phone app and clicking the deactivate button. The benefit of the alternative is that some watches, like the Apple watch limits some of the button and input features on the phone. Other devices like a pendant can be programed to permit a 5 second hold on a pendant button to deactivate the device. When the team members’ (officers’) work shift is over, the team members deactivate or turn off the emergency alert application. The member’s devices will no longer receive any alerts.

### BRIEF DESCRIPTION OF THE DRAWINGS

FIG. 1 is a flow chart showing part of the inventive system.

FIG. 2 is a flow chart showing part of the inventive system.

FIG. 3 is a flow chart showing part of the inventive system.

FIG. 4 is a flow chart showing part of the inventive system.

FIG. 5 is a screenshot of the screen of a mobile device for one embodiment of the inventive system.

FIG. 6 is a screenshot of the screen of a mobile device for one embodiment of the inventive system.

FIG. 7 is a screenshot of the screen of a mobile device for one embodiment of the inventive system.

FIG. 8 is a screenshot of the screen of a mobile device for one embodiment of the inventive system.

FIG. 9 is a screenshot of the screen of a mobile device for one embodiment of the inventive system.

FIG. 10 is a screenshot of the screen of a mobile device for one embodiment of the inventive system.

### DETAILED DESCRIPTION OF THE INVENTION

The invention is an emergency tracking device and system that allows first responders to a scene to be directly alerted to the location of a person in need of assistance and to receive information in real time about the person in need without information having to first travel to an intermediary, relay point or a middleman. It directly alerts those first responders or individual that will be first to the scene. As opposed to similar applications such as LifeAlert that notifies an intermediary emergency system like 911, the invention allows a pre-determined team of responders or individuals to track a person-in-need’s exact location without the need to share a team member’s location indefinitely. It allows those in need to be found when they are in need of assistance.

The inventive app (such as an iOS app) allows users to create, update, modify, or delete their user account and/or Team affiliations. Upon launching, users are prompted with the ability to sign in or create an account.

The invention is ideal for an officer on patrol that gets into an altercation in which he requires assistance. While in the altercation, the officer in distress typically must grab his radio to call for assistance. However, during the call, he must be clear and accurate in describing his location, which many times can be difficult to do because he is in a fight of flight mode, making simple acts much more difficult. During the call, the officer might be yelling, confused, and the transmission may be difficult to hear during the altercation. Keeping those who wish to assist updated about the officer’s location during a rapidly changing situation can also be difficult. With the invention, a call for assistance is just a click of a button and allows the officer to focus on resolving the altercation while assisting teammates are on their way. In one embodiment, all the teammates’ phones will be sent a notification allowing them to just click and GPS directions will automatically be displayed on the teammates’ phones so they can start traveling to aid the officer requiring assistance.

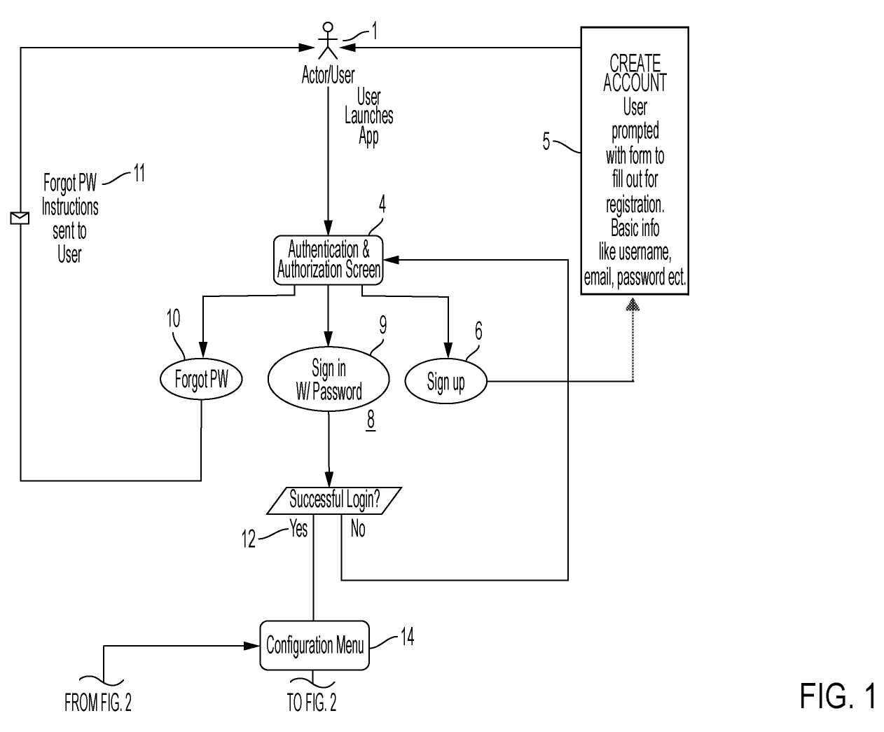

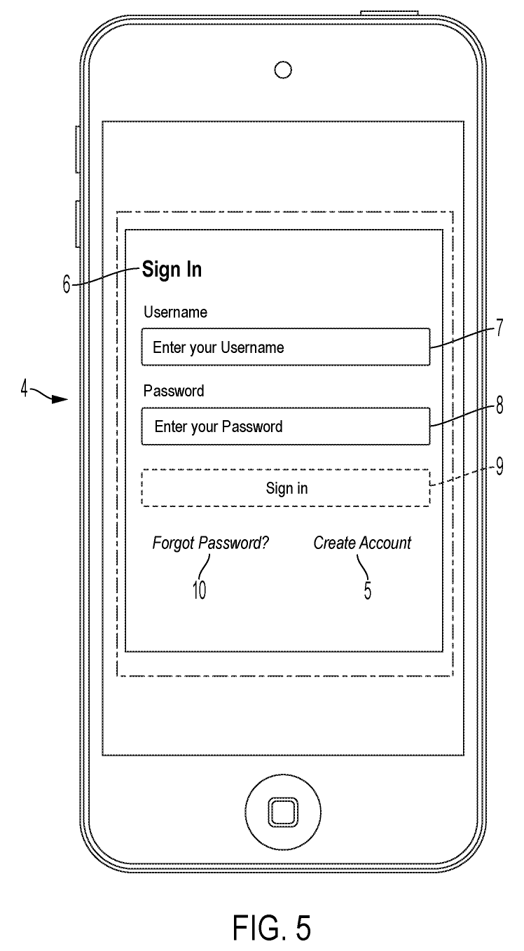

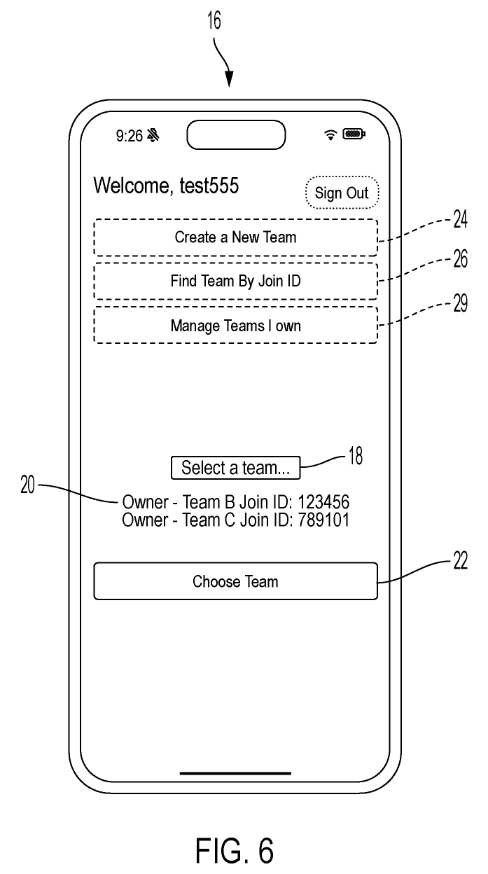

FIG. 1 Shows a flow chart of the initial steps of the inventive system. The system starts with an actor or user 1 who launches the application and sees the authentication and authorization screen 4 on the mobile device. FIG. 5 shows an example of an authentication and authorization screen 4 on a mobile. A first-time user 1 can sign up 6 to use the app by creating an account 5 and will be prompted with a form to fill out for registration. It includes basic information like user name, email, set password, etc. A user who is already registered uses a simple sign in 9 with a username 7 and a password 8. If the user cannot remember their password 10, forgot password instructions 11 are sent to user 1. If login is successful 12, the user goes to a screen with a configuration menu 14, one example of a display and arrangement of the a configuration menu 16 can be seen in FIG. 6. If login is unsuccessful the user is sent back to the authentication and authorization screen 4.

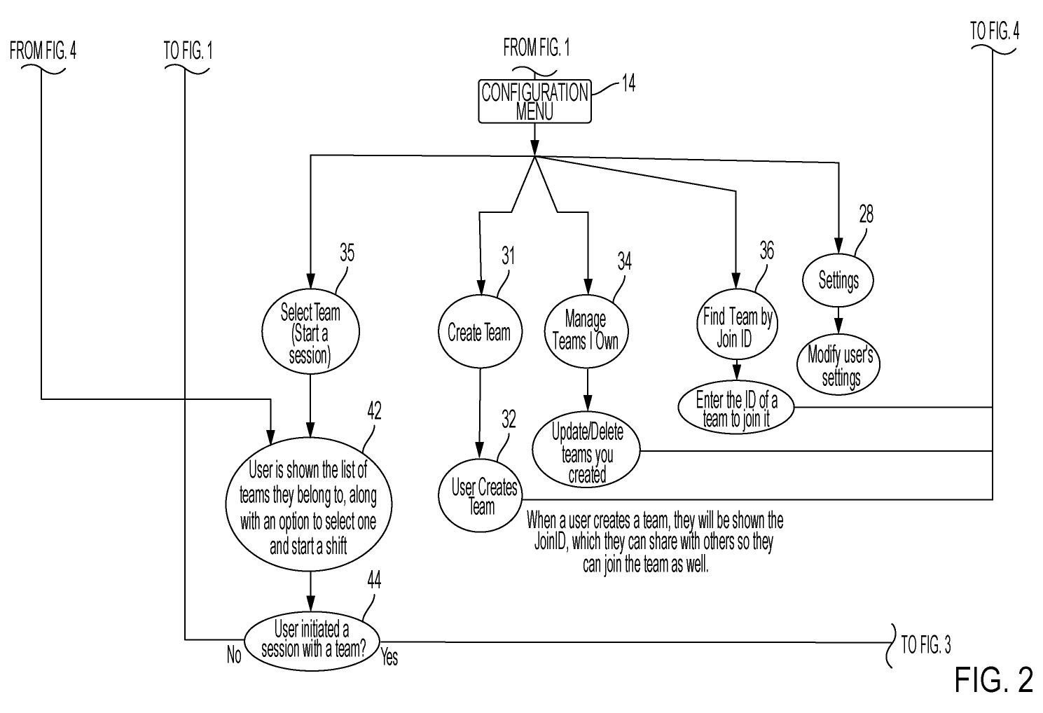

FIG. 2. Shows a flow chart of the configuration menu 14 in a team management page format 16. FIG. 6 is an example of a display image on a mobile device of a team management format page 16. Team information and join ID identifications and names are stored in a secure server in a cloud-based database.

There is a Select Team button 18, 35 that allows a user to start a session. The user is shown the list of teams they belong to, along with an option to select one of the listed teams 20, 42 which will start a shift session. They can start a shift by highlighting the team and hitting Choose Team 22, 44. The select team button allows the user to select from the list of teams they are already a part of, but not currently signed into, along with an option to select one to start a shift 42. Once the user hovers over a team name 20 the choose team button 22 becomes enabled, allowing them to start a working shift session on that team 44.

As seen in FIG. 2, the user can create a team 31, as an example, with a button 24 on the mobile screen shown in FIG. 6. When a user creates a new team 24, 32, a join identification, join ID, is generated by the system which then must be used for any future users to join the new team 32. The user creating the new team 24, 32, will be shown the find team by join ID tab 26, 36 in which a user is given a join ID identification which can be a name, number or any combination number or name the user creates when they create a team. In one embodiment, the join ID identification is a randomly generated Globally unique identifier (GUID). This ID, can then be shared with users or responders to allow them to join the team as well 32. Once a new user has the join ID for a team, the new user can find that team by using the join ID tab 26, 36 and entering the join ID of the team it wants to join.

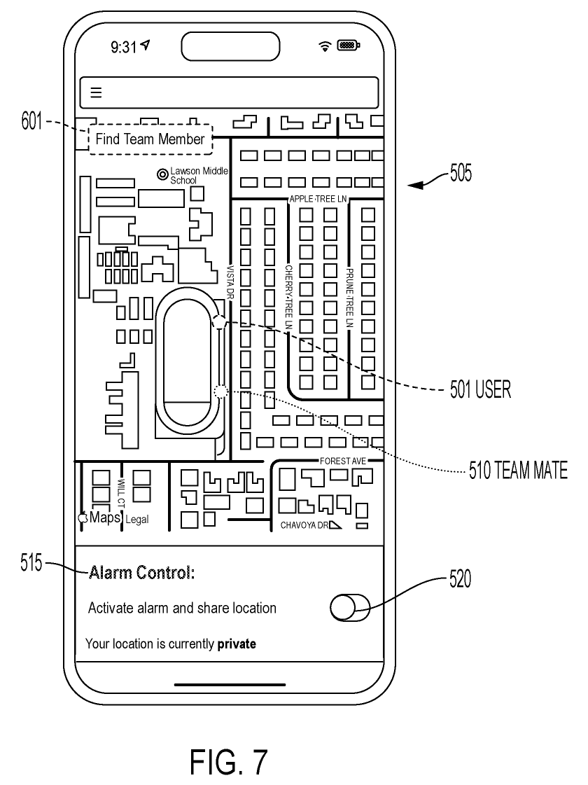

In FIG. 2, the screenshot The Manage Teams I Own step 34, allows a user or responder to update, make modifications and delete teams they own or created using a button 29 such as shown on the screen shown in FIG. 6. The Find Team by Join ID step 26, 36, is another feature that allows someone to find a particular team that was created by someone else. Once someone enters the proper ID of a team they can join that team. An example of a Find Team By Join ID button 26 displayed on a device screen is shown in FIG. 6. There is also a Settings feature 28 which allows a user to modify their settings. Once an account is created and a user signs in, they land on the team management console display shown in FIG. 6. Once a user chooses a team 22, 35, it triggers the beginning of a working session. FIG. 7 is a screenshot of one embodiment of the invention showing the screen on a mobile device when a team session begins. In this example, the Alarm Control toggle or switch has not been activated by the user and user’s location is still private.

In FIG. 7, the screenshot shows a first marker 501 indicating the current user’s position. A second marker 510 indicates the position of a teammate, who previously joined the team, who is actively calling for help by activating their device. In the preferred embodiment the user can see the teammate requesting assistance because the user 501, previously clicked the Find Team Member button 601 on the screen. The map 505, will update in real time as either the user, or other team members who are calling for help, physically move through the world. The map 505 is updated as the teammate 510 calling for help or needing assistance, moves and their device transmits new GPS coordinates to the system server. The system server then transmits the new coordinates of the teammate needing assistance 510, to the devices of all the active teammates to update all the active teammates. The time interval between updates can be predetermined. Preferably, the updates occur sometime between 3 seconds and 3 minutes. Preferably, updates every 30 seconds is desired. While frequent updates are desirable, they can more quickly reduce the battery life of devices transmitting and they can increase the costs associated with using the system as it can be very expensive to pay for a cellular service that is constantly sending data for updating locations over short intervals of just a few seconds. Lengthening the time interval between updates can substantially reduce the cell and data charges incurred during use of the system.

The Alarm Control 515 feature is to keep a user’s position 100% private when not in alarm mode. The GPS coordinates never leave the phone. On this screen the Alarm Control slider 520, is shown in the left position indicating the alarm has not been activated and the user’s position is not being shared. Upon activating the Alarm Control 515, by sliding the Alarm Control slider 520, to the right the screen changes to indicate that the GPS coordinates are being shared. However, they are only being shared with teammates that are joined to the team at that time.

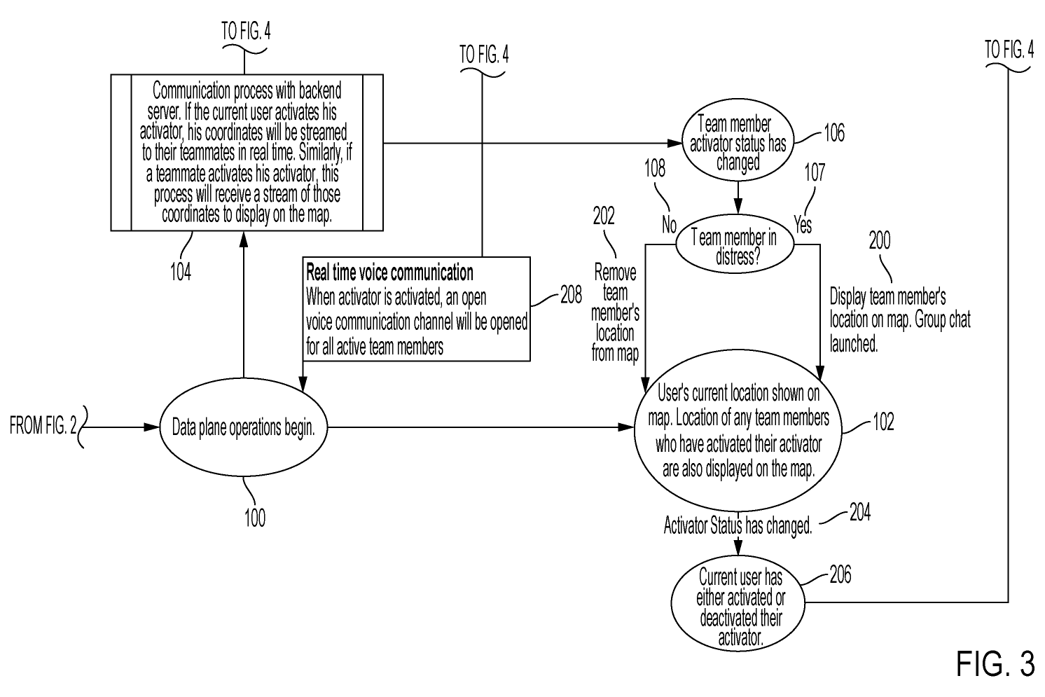

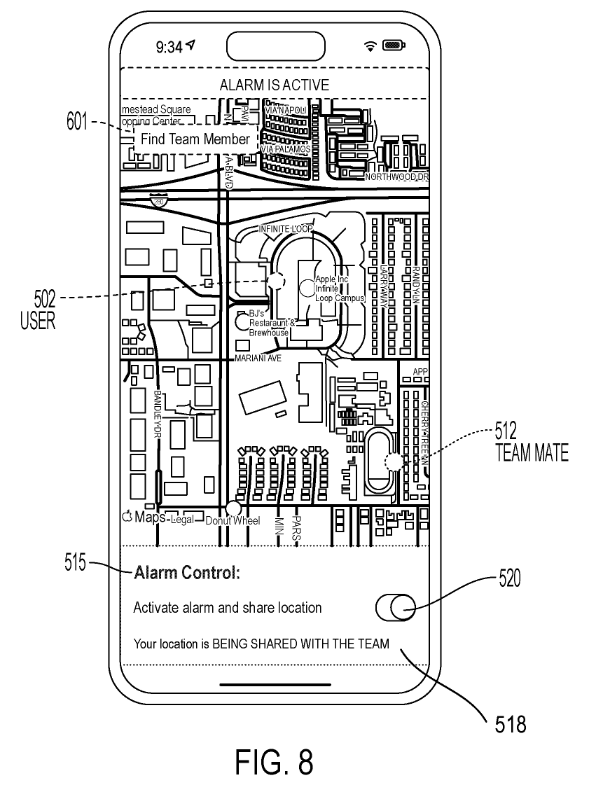

In FIG. 8, the screenshot from another embodiment shows the Find Team Member button 601 near the top of a map. When the Find Team Member is activated it provides a list of team members who are actively calling for help and then transmits to the user directions requiring the shortest period of time to reach each team member in need of help. In FIG. 8, the Alarm Control slider 520, has been shifted to the right thus activating the alarm. The user’s location is now shown “BEING SHARED WITH THE TEAM” 518. This means that other team members can now see this user’s location 502 along with the location of the first team mate 512 that activated their alarm and shared their location. In this example , two team members have each activated their own alarm to share their location with other team members. It is not possible to locate team members who are not calling for help through the mobile application, as that would violate the promise that a user’s location is 100% private until they call for help. As shown in FIG. 3, once initiated a user's current location is shown on the map 102 the location of any team members who have activated their activator are also displayed on the map.

FIG. 3. is a flow chart showing what happens with a user initiated session. The data plane operations 100 begin at this point. For the system and method to work there is a team member location synchronization service. In this phase there is a communication process with a backend server 104. If the current user activates their activator, the current user’s coordinates will be streamed to the teammates in real time. In one embodiment, there is only one activator status, the emergency alert. Similarly, if a second teammate activates their activator, all the other teammates will receive a second set of coordinates to display on their map. If a team member’s activator status has changed 106, the display will change. Using the inventive system, a team member’s status is reviewed to see if they are in distress 108. If Yes, 107, then the team member's location is displayed on the map and a Group chat 200 is launched. If the team member is not in distress, remove team member's location is removed from the map 202. Activator Status is changed 204 when the Current user has either activated or deactivated their activator 206.

If the current user makes a change, the Current user activator has a status change event. If the current user activate's their activator, their GPS coordinates will begin being shared with their team through the system server. If they deactivate their activator, their coordinates will stop being shared with their team. In one embodiment, this change event of one activating their activator launches a group call amongst all the active team members. In one embodiment, if a group call is activated, only the activator of the alert will be able to talk on the group call while those coming to help and assist can only listen to the call.

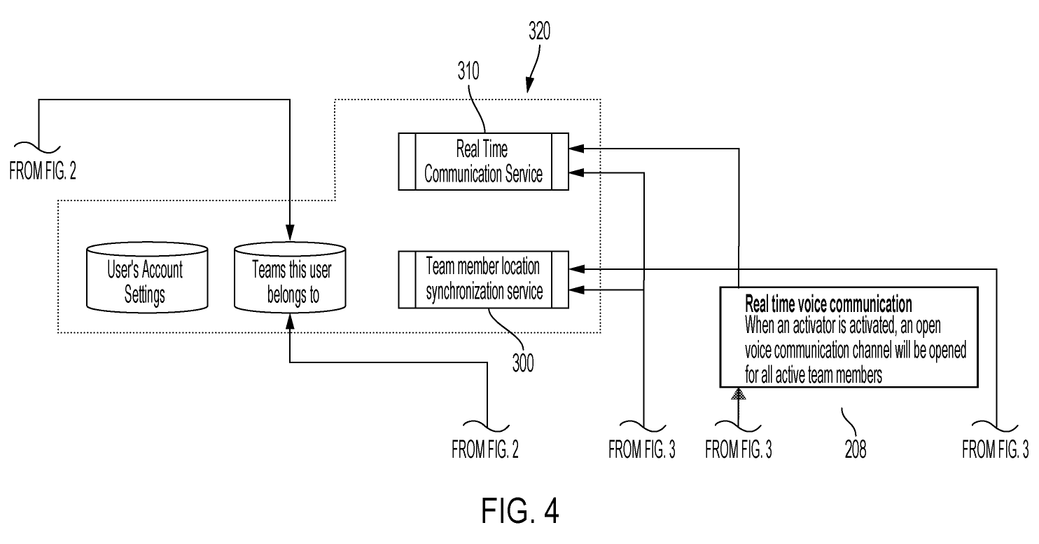

Real Time Voice Communication Service 208 will occur when an activator is activated and an open voice communications channel is opened for all active team members. As shown in FIG. 4, a Back End System 320 can be part of the inventive system. The back end system 320 includes a mobile app and the engine that allows for real-time communication 310 between team members. If a user initiates a session with a team, the Data plane operations begin 100. At this phase, the configuration screen with the configuration Menu 14 closes and the working session screen is launched. A map will launch showing the current user's location 102, 501.

As shown in FIGS. 3 and 7. There will be an option to exit the session as well as options to find team members in distress. If there are team members in distress, their locations 510 will appear on the map. There will be a switch, toggle or button 520, that when moved or activated, will share the GPS location of the current user with the team members.

As used in the invention, an Activator can be one of several things. It can be either the switch on a phone screen as previously described, a button or dial on smart watch, or the button or dial on a custom piece of hardware or device such as a pendant. When the Activator is "activated", the user's GPS locations will be shared with the team. Once the activator is deactivated, the user's GPS locations will return to private. At no time will the GPS location of the user be shared unless they explicitly activate their activator.

A control plane device is a device that the user uses to create an account, sign in, configure their account level settings and configure their teams. This device preferably has a screen, microphone, speaker and SIM card, for example it could be mobile phone such as an android or iPhone. This device may be the source of the GPS coordinates, depending on the hardware limitations of the data plane device.

A data plane device is a device containing the activator. It could be the same as the control plane device, or it can be an Apple watch™, Google™ watch, or an independently developed custom pendant. This device may be the source of the GPS coordinates, depending on the hardware limitations of this device.

A pendant is a separate hardware and software component which can be designed to be used with the app running on a mobile phone. The purpose of pendant is to provide a user or a teammate a means to track and transmit their GPS coordinates to others while providing an activator to begin sharing the GPS coordinates. In one embodiment, the pendant can be a circular or oval shape and the approximate size of quarter. Flat in shape with rounded sides. The front face of the pendant can have a flat button that can be easily clicked when pressure is applied. The flat button can have rubber/ridged markings to provide friction. The edge of pendant will have a ring which is able to be illuminated. The pendent would have a Bluetooth or chip to allow it to connect to a cellular phone, a cell chip/SIM card to allow it to communicate to the server via a cellular network, and a GPS chip to allow it to transmit its geolocation.

The user will be able to use the settings on their cell phone to configure how often the pendant pushes out its location to a server that would then share that location with other teammates. How often the pendent pushes out its location can be based on time, distance or a combination of both. The more often a location is pushed out the more quickly the battery life of the phone and pendent will be reduced. In one embodiment the location would be sent every 2.5 feet of lateral movement. In another embodiment the location would be sent every 50 yards of lateral movement to preserve battery life.

The pendant would be linked to the user’s cell phone where it is set up to a user’s preferences. The pendant has its own GPS signal however the signal would not be shared unless the pendant is intentionally activated. Once set up, the pendant would be able to function without the user’s cell phone being present. In one embodiment, when an alert comes in from another user’s pendant, the edge of the pendant would blink red signaling that another user’s alert is being signaled.

The pendant can be configured in any number of ways and be carried in a number of different ways as may be preferred by a user. The pendant is configured to be easily attached/interchanged and held together with a bracket. A clip, bracelet or other attachment devices can be used to attach the pendant to the user.

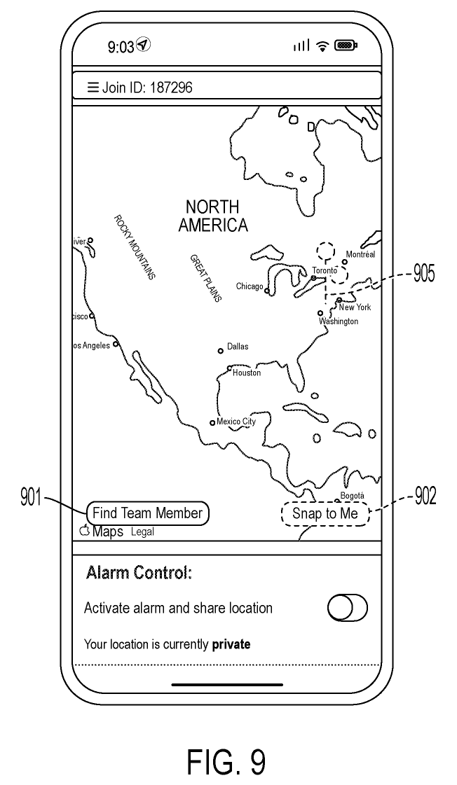

One screen shot from one embodiment of the invention is shown in FIG. 9 which includes a “Find Team Member” Button 901 and a Snap to Me button 902. When no team members have their alarms activated, the “Find Team Member” button is displayed in a why indicates it is disabled, for example in a dull gray color. Clicking on that button 901 when no team member has activated their alarm will cause no changes to the map display. The Snap to Me button 902 is more vividly displayed, for example in a blue color to indicate it is active, and in this situation and clicking on that button 902 will cause a pin 905, sharing the same color as the Snap to Me button, to appear on the map indicating the user’s location.

As shown in an embodiment in FIG. . when a team member activates their alarm, the following changes appear on the screen:
1. That team member appears on the screen, for example as a colored red pin 1001.
2. The “Find Team Member” button 1010 turns red and becomes enabled (clickable).
3. The iPhone receives a push notification.
3a. The phone will continue to receive push notifications until the user either clicks the notification OR clicks the “Find Team Member” button and selects the teammate who is in alarm. This is to ensure no alarms are missed.

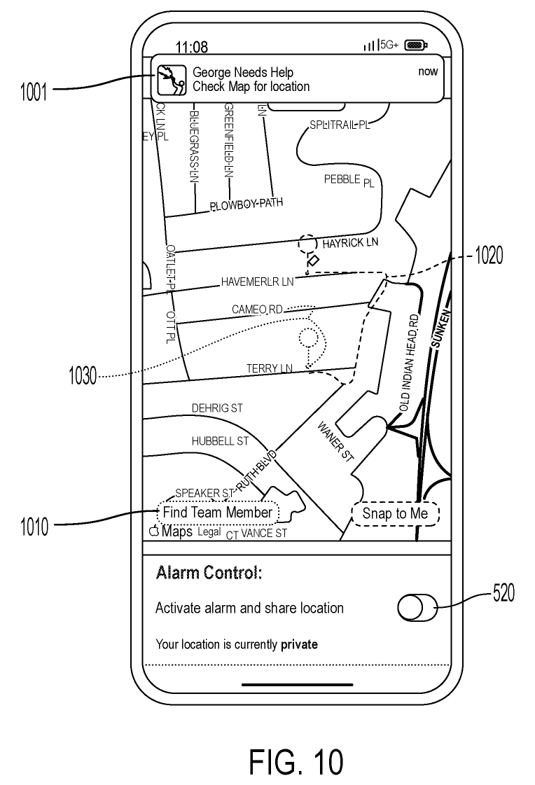

In the embodiment shown in FIG. 10, clicking on an individual will launch a route 1020 to that person as provided by a GPS routing provider. The present location of the user could be shown with a pin or some other icon, preferably in the same color use for the Snap to Me tab. The location of the route could also be drawn using that same color.

As user approaches the person, a second route will be drawn 1030. The second route 1030 could be drawn in different color such as red. This second route 1030 is the “bread crumb trail”, or the actual path that the individual seeking assistance has taken since activating their alarm. It is possible that the route drawn by a GPS route provider will not be the optimal route to reach the individual, if that individual has jumped fences or went the wrong way down one-way streets (as is often the case with police pursuits). For example, a team member in an altercation may have run through a dead end, through a property and out into the street behind the dead end. The team member in need of assistance may have activated their alarm so therefore the trail starts 1030 where they hit the alarm and ends 1050 at their current location.

Having thus described several aspects of at least one embodiment of this invention, it is to be appreciated that various alterations, modifications, and improvements will readily occur to those skilled in the art. While the invention has been described in connection with what is presently considered to be the most practical and various embodiments, it is to be understood that the invention is not to be limited to the disclosed embodiments. Such alterations, modifications, and improvements are intended to be part of this disclosure, and are intended to be within the spirit and scope of the invention.

What is claimed is:

1. An emergency alert and tracking system comprising:
a server configured to store team information associating a plurality of users with a predetermined team;
a first mobile device associated with a first user of the predetermined team, the first mobile device including an activator and being configured to determine location coordinates of the first user;
a plurality of responder devices respectively associated with other users of the predetermined team and configured to receive alert information from the server;
wherein the first mobile device is configured to maintain the location coordinates of the first user as private before activation of the activator;
wherein, in response to activation of the activator, the first mobile device is configured to transmit the location coordinates of the first user to the server, and the server is configured to transmit the location coordinates of the first user to the plurality of responder devices in real time;
wherein each responder device of the plurality of responder devices is configured to display, on a map, a location of the first user based on the location coordinates of the first user; and
wherein the emergency alert and tracking system is configured to stop sharing the location coordinates of the first user with the plurality of responder devices in response to deactivation of the activator.

2. The emergency alert and tracking system of claim 1, wherein the first mobile device is configured to activate an alarm in response to detecting a plurality of successive actuations of the activator, transmit the location coordinates of the first user to the server while the alarm is activated, and turn off the alarm in response to detecting a continuous actuation of the activator for a predetermined duration.

3. The emergency alert and tracking system of claim 1, wherein each responder device of the plurality of responder devices is configured to update the map by displaying a path taken by the first user, the path being generated from successive location coordinates of the first user received from the server after activation of the activator.

4. An emergency alert and tracking system comprising:
a cloud-based server configured to store team information for a predetermined team of team members, the team information including a join identification generated when the predetermined team is created;
a first mobile device associated with a first member of the predetermined team and configured to run a mobile application that authenticates the first member, starts a working shift session for the predetermined team, and displays a map during the working shift session;
a pendant associated with the first member, the pendant having an activation button, a Bluetooth chip configured to connect the pendant to the first mobile device, a cellular chip configured to communicate with the cloud-based server via a cellular network, and a GPS chip configured to determine GPS coordinates of the pendant;
a plurality of responder mobile devices respectively associated with other team members of the predetermined team and configured to run the mobile application during the working shift session;
wherein the pendant is configured to maintain the GPS coordinates of the pendant as private such that the GPS coordinates are not shared with the predetermined team before activation of the activation button;
wherein the pendant is configured, in response to at least three successive pushes of the activation button, to activate an alarm, transmit the GPS coordinates of the pendant to the cloud-based server via the cellular network, and cause an alert at the mobile device associated with another team member of the predetermined team;
wherein the cloud-based server is configured, while the alarm is activated, to transmit updated GPS coordinates of the pendant to the plurality of responder mobile devices at a predetermined update interval between three seconds and three minutes; and
wherein each responder mobile device of the plurality of responder mobile devices is configured, in response to receiving the updated GPS coordinates, to display on the map a colored pin corresponding to a current location of the pendant, enable a Find Team Member button, provide push notifications until the Find Team Member button or a corresponding notification is selected, display a route from a location of the responder mobile device to the current location of the pendant, and display a breadcrumb trail representing an actual path traveled by the pendant after activation of the alarm.

5. The emergency alert and tracking system of claim 4, wherein the pendant further includes a Bluetooth chip configured to connect the pendant to the first mobile phone, a cellular chip configured to communicate with the cloud-based server via a cellular network, and a GPS chip configured to determine GPS coordinates of the pendant.

6. The emergency alert and tracking system of claim 4, wherein the emergency alert and tracking system is configured, in response to activation of the alarm, to open a real-time voice communication channel among active team members of the predetermined team in which only the first team member is permitted to talk and the other team members of the predetermined team are permitted to listen; and
wherein the pendant is configured, in response to holding the flat button down for five seconds, to deactivate the alarm and stop transmitting the GPS coordinates of the pendant to the cloud-based server.

7. The emergency alert and tracking system of claim 8 wherein the mobile device is a mobile phone.

8. The emergency alert and tracking system of claim 4, wherein the pendant is a smart watch.
